(19) United States
(12) Patent Application Publication
(10) Pub. No.: US 2015/0058639 A1
(43) Pub. Date: Feb. 26, 2015

(54) ENCRYPTION PROCESSING DEVICE AND STORAGE DEVICE

(71) Applicant: Kabushiki Kaisha Toshiba, Minato-ku (JP)

(72) Inventor: Shinya HASEGAWA, Kawasaki-shi (JP)

(73) Assignee: Kabushiki Kaisha Toshiba, Minato-ku (JP)

(21) Appl. No.: 14/108,659

(22) Filed: Dec. 17, 2013

Related U.S. Application Data
(60) Provisional application No. 61/869,181, filed on Aug. 23, 2013.

(51) Int. Cl. G06F 21/60

(52) U.S. Cl. CPC G06F 21/602
USPC 713/190

(57) ABSTRACT

According to one embodiment, an encryption processing device includes a plurality of generating circuits to generate respective mask values for respective second data units, by using identification information to identify a first data unit and first key data, wherein the first data unit includes the second data units, each of which serves as a unit of an encryption operation, and a plurality of arithmetic circuits encrypting the respective second data units, by using the respective mask values, the second data units, and second key data, wherein the generating circuits perform parallel processing.

### CROSS-REFERENCE TO RELATED APPLICATIONS

This application claims the benefit of U.S. Provisional Application No. 61/869,181, filed Aug. 23, 2013, the entire contents of which are incorporated herein by reference.

### FIELD

Embodiments described herein relate generally to an encryption processing device, an encryption processing method, and a storage device.

### BACKGROUND

Storage devices including nonvolatile semiconductor memories, such as NAND flash memories, are used in various fields. Nowadays, with an increasing awareness of security, it is required to perform encryption also when data is stored in a storage device. For example, a common key cryptosystem or secret key cryptosystem using a common (same) key in encryption and decryption is known as an encryption system.

### BRIEF DESCRIPTION OF THE DRAWINGS

FIG. 1 is a block diagram of a storage device 20 according to a present embodiment;

FIG. 2 is a block diagram illustrating some of the modules included in a controller 21;

FIG. 3 is a block diagram of an encryption processing device 23;

FIG. 4 is a block diagram of an encryption arithmetic circuit 32;

FIG. 5 is a schematic diagram illustrating encryption processing in an AES-XTS mode;

FIG. 6 is a flowchart of the encryption processing in the AES-XTS mode;

FIG. 7 is a flowchart of encryption processing according to the present embodiment;

FIG. 8 is a diagram illustrating a timing for performing processing for a plurality of blocks according to a comparative example; and

FIG. 9 is a diagram illustrating a timing for performing processing for a plurality of blocks according to the present embodiment.

### DETAILED DESCRIPTION

In general, according to one embodiment, an encryption processing device comprises: a plurality of generating circuits to generate respective mask values for respective second data units, by using identification information to identify a first data unit and first key data, wherein the first data unit includes the second data units, each of which serves as a unit of an encryption operation; and a plurality of arithmetic circuits encrypting the respective second data units, by using the respective mask values, the second data units, and second key data, wherein the generating circuits perform parallel processing.

[1. Configuration of Storage Device]

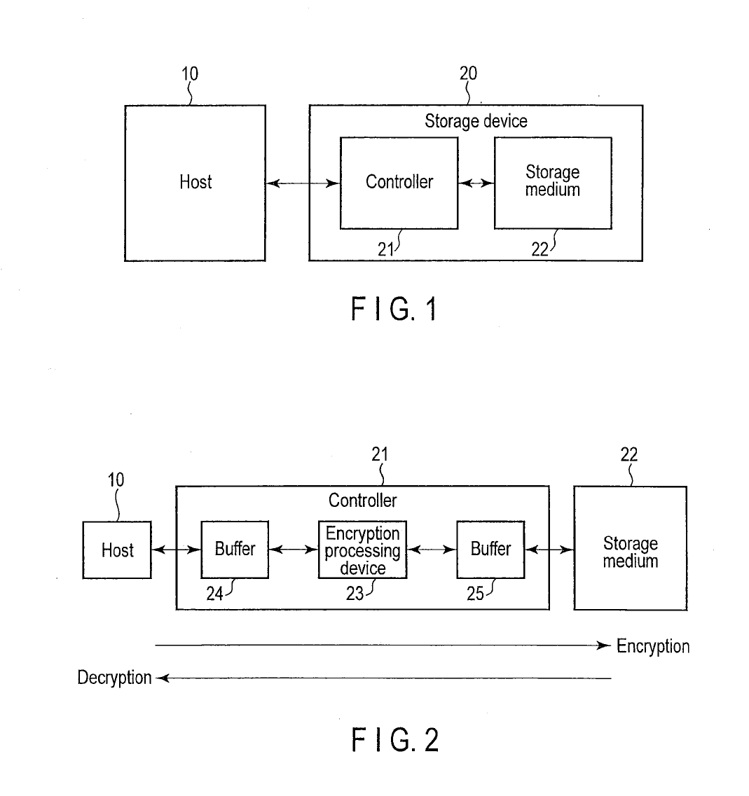

FIG. 1 is a block diagram of a storage device 20 according to the present embodiment. The storage device 20 comprises a controller 21, and a storage medium 22. The storage device 20 operates, for example, in a state of being connected to a host 10 and supplied with electric power, and performs processing in accordance with an access request from the host 10. The host 10 includes hardware and software to access the storage device 20 connected thereto via an interface.

The controller 21 performs interface processing between the storage device 20 and the host 10, and controls operations (including data writing operation, data reading operation, and data erasing operation) of the storage medium 22 in accordance with an access request from the host 10.

The storage medium 22 is formed of, for example, a nonvolatile semiconductor memory. Specifically, a NAND flash memory, an MRAM (Magnetic Random Access Memory), or the like is used as the storage medium 22.

FIG. 2 is a block diagram illustrating some of the modules included in the controller 21. The controller 21 includes an encryption processing device 23, and buffers 24 and 25. The encryption processing device 23 performs encryption processing for data transmitted from the host 10, and performs decryption processing for data transmitted from the storage medium 22. In the present embodiment, an encryption algorithm of a common key cryptosystem is used. Specifically, the present embodiment is described by showing an example in which the encryption system of the encryption processing device 23 is an XTS (Xor-Encrypt-Xor Tweaked codebook with Ciphertext Stealing) mode, and a common key encryption algorithm used for encryption operation is AES (Advanced Encryption Standard) (referred to as “AES-XTS mode”), but the present embodiment is not limited to the example.

In encryption, data flows in the order of the buffer 24, the encryption processing device 23, the buffer 25, and the storage medium 22. In decryption, data flows in the order of the storage medium 22, the buffer 25, the encryption processing device 23, and the buffer 24. In the encryption operation, the buffer 24 temporarily stores data transmitted from the host 10, and the buffer 25 temporarily stores data encrypted by the encryption processing device 23. In the decryption operation, the buffer 25 temporarily stores data transmitted from the storage medium 22, and the buffer 24 temporarily stores data decrypted by the encryption processing device 23.

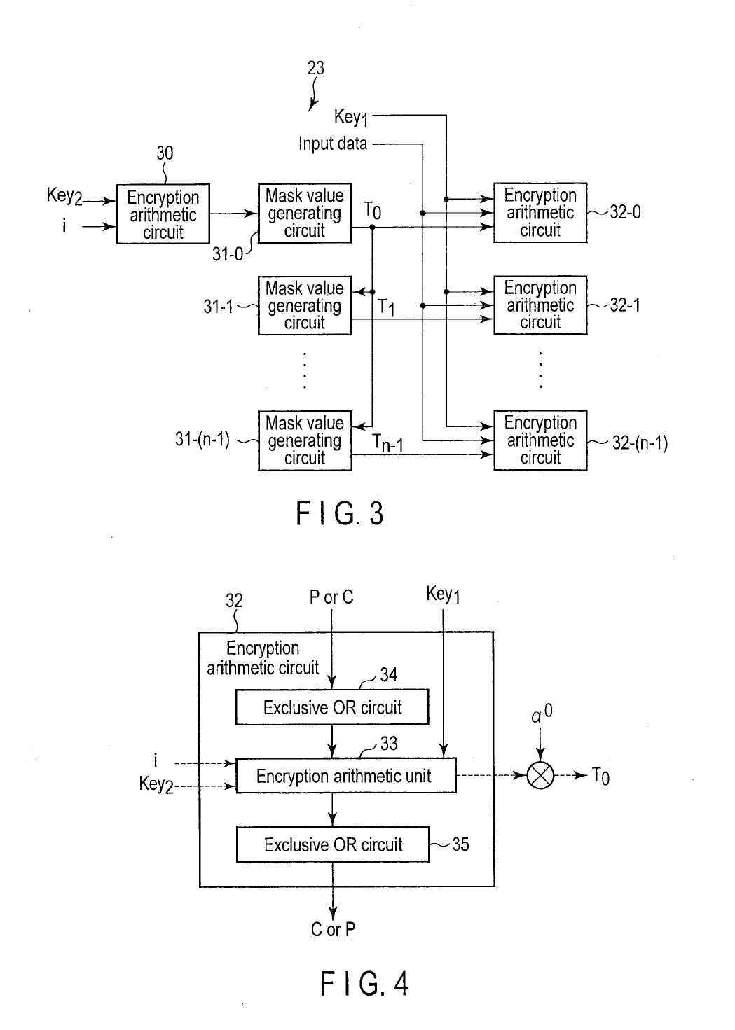

FIG. 3 is a block diagram of the encryption processing device 23. The encryption processing device 23 performs encryption processing for each data unit (block) of a predetermined size, encrypts input data for each block, and generates encrypted data. In addition, for example, writing from the controller 21 to the storage medium 22 is also performed for each block. A block is configured based on an encryption system to be used; and in the present embodiment, the size of a block is 128 bits (16 bytes), for example. In addition, a plurality of blocks form a sector; and in the present embodiment, a sector is formed of 512 bytes, as an example. Although the data size of a sector may be other than 512 bytes, a sector having a size x times (x is an integer) as large as a block is used herein. Access from the host 10 to the storage device 20 is performed for each sector. The size of a sector is determined according to the interface between the host 10 and the storage device 20.

The encryption processing device 23 can perform encryption processing for a plurality of blocks in parallel. To perform parallel processing, the encryption processing device 23 includes an encryption arithmetic circuit 30, mask value generating circuits 31-0 to 31-(n−1), and encryption arithmetic circuits 32-0 to 32-(n−1). The number n of blocks, which are processed in parallel, can be set to a desired value. The number n is equal to or smaller than the number of blocks that form a sector.

The encryption arithmetic circuit 30 generates original data for generating a mask value, by using key data Key₂ and a tweak value i. In the present embodiment, for example, a sector number is used as the tweak value i.

The mask value generating circuits 31-0 to 31-(n−1) generate mask values T₀ to Tₙ₋₁, respectively, used for encryption and decryption. Specifically, the mask value generating circuit 31-0 receives the original data from the encryption arithmetic circuit 30, and generates a mask value T₀ by using the original data. The mask value generating circuits 31-1 to 31-(n−1) generate mask values T₁ to Tₙ₋₁, respectively, by using the mask value T₀.

The encryption arithmetic circuits 32-0 to 32-(n−1) receive the respective mask values T₀ to Tₙ₋₁ from the mask value generating circuits 31-0 to 31-(n−1), respectively. Each of the encryption arithmetic circuits 32-0 to 32-(n−1) also receives corresponding input data (block). Each of the encryption arithmetic circuits 32-0 to 32-(n−1) encrypts and decrypts the input data by using the key data Key₁ and the mask value T.

FIG. 4 is a block diagram of an encryption arithmetic circuit 32. Each encryption arithmetic circuit 32 includes an encryption arithmetic unit 33, and exclusive OR circuits 34 and 35.

First, processing relating to encryption operation will be explained hereinafter. The exclusive OR circuit 34 calculates an exclusive OR between the input data (data to be encrypted) P and the mask value T. The encryption arithmetic unit 33 performs an encryption operation (including encryption and decryption) based on the AES-XTS mode. The exclusive OR circuit 35 calculates an exclusive OR between the data output from the encryption arithmetic unit 33 and the mask value T, and outputs encrypted data C. In the decryption operation, encrypted data C is input to the exclusive OR circuit 34, and decrypted input data P is output from the exclusive OR circuit 35 through the encryption arithmetic unit 33.

In addition, the encryption arithmetic unit 33 is configured to also be capable of performing processing performed by the encryption arithmetic circuit 30 illustrated in FIG. 3. Specifically, the encryption arithmetic unit 33 generates original data for generating a mask value, by using key data Key₂ and a tweak value i. Thus, in the configuration example of the present embodiment, the encryption arithmetic circuit 30 illustrated in FIG. 3 does not exist independently, but is included in one of the encryption arithmetic circuits 32.

[2. Operation]

Next, operation of the storage device 20 configured as described above will be explained hereinafter.

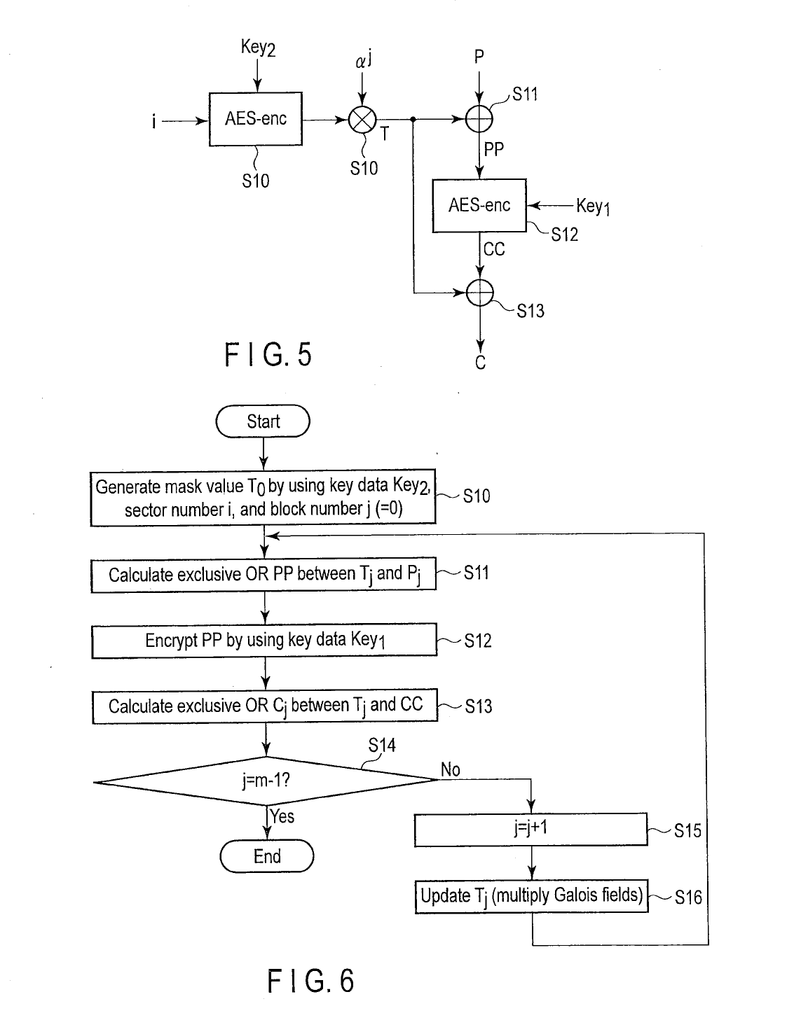

First, general encryption processing in the AES-XTS mode will be explained hereinafter. FIG. 5 is a schematic diagram illustrating encryption processing in the AES-XTS mode. FIG. 6 is a flowchart of encryption processing in the AES-XTS mode.

As described above, in the present embodiment, the AES-XTS mode is used as an encryption system, and a sector number (sector identification information) is used as the tweak value i used for generating the initial mask value T₀. Moreover, in the AES-XTS mode, key information is used, and the key information is formed of a pair of the key data Key₂ for generating the initial mask value T₀ and the key data Key₁ for encrypting the data. The key information may be determined for any unit of data. For example, the storage medium 22 is divided into a plurality of areas, and the same key information is used for a divided area. For example, when the storage medium 22 has a capacity of 128 GB, the same key information is used for 32 GB. Thus, the same key information is used for sectors belonging to the same area. Suppose that the controller 21 holds correspondence between the key information and the area, and correspondence between the area and sector numbers in the area, and recognizes key information used for the sector numbers.

Suppose that the sector number is i (i is an integer of 0 or more), and a block number of the block to be processed is j (j is an integer of 0 or more). When encryption processing is successively performed for a plurality of sectors, the sector number is updated, and the processing illustrated in FIG. 5 is repeated.

First, an initial mask value T₀ is generated based on the following expression (1), by using the key data Key₂, the sector number i, and the block number j (j=0) (Step S10). The reference symbol “Enc ( )” represents an encryption operation in the AES-XTS mode, and the reference symbol “α^{j}” (j=0, 1, 2, . . . , m−1) is a primitive element of a Galois field. Reference symbol m denotes the number of blocks that form a sector.

T₀=Enc(Key₂,i)×α⁰ (1)

Next, a data encryption operation is started. First, an exclusive OR between input data (data to be encrypted) Pⱼ corresponding to the jth block and the mask value Tⱼ is calculated, based on the following expression (2), and a calculation result PP is obtained (Step S11).

PP=Pⱼ xor Tⱼ

Next, the calculation result PP is encrypted by using the key data Key₁, based on the following expression (3), and a calculation result CC is obtained (Step S12).

CC=Enc(Key₁,PP) (3)

Then, an exclusive OR between the mask value Tⱼ and the calculation result CC is calculated based on the following expression (4), and encrypted data Cⱼ is obtained (Step S13).

Cⱼ=CC xor Tⱼ (4)

Next, it is determined whether j is equal to “m−1” (specifically, whether the block is the last block of the sector) or not (Step S14). When j is equal to “m−1” (Step S14: Yes), the encryption processing of the sector is ended. When J is not equal to “m−1” (Step S14: No), the block number j is incremented by 1 (Step S14). Then, the mask value Tⱼ is updated based on the following expression (5) (Step S15), and the process returns to Step S11.

Tⱼ=Tⱼ₋₁×α^{j-1} (5)

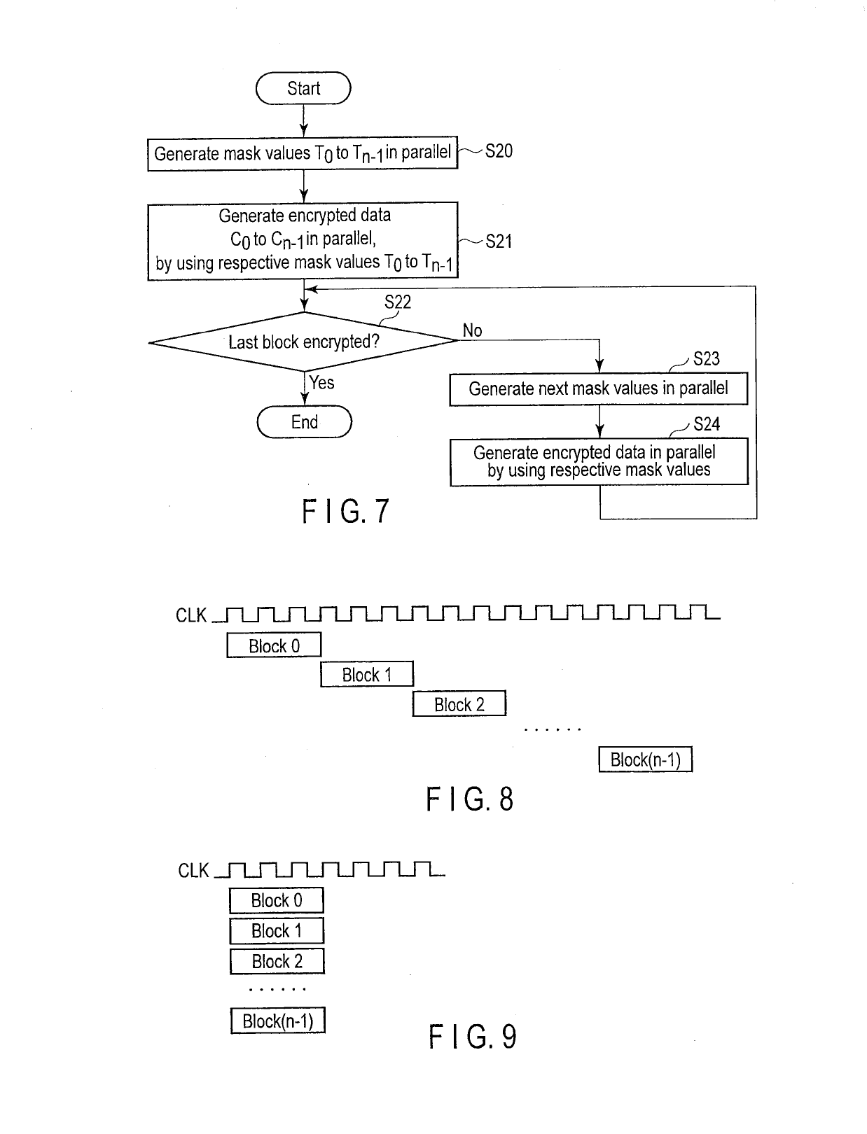

In the present embodiment, mask value generation processing is performed in parallel. To perform the parallel processing, the encryption processing device 23 includes n mask value generating circuits 31-0 to 31-(n−1), as illustrated in FIG. 3. FIG. 7 is a flowchart of encryption processing according to the present embodiment.

First, the mask value generating circuits 31-0 to 31-(n−1) generate mask values T₀ to Tₙ₋₁, respectively, in parallel (Step S20). The term “parallel processing” used herein means generating mask values T₀ to Tₙ₋₁ in parallel in the same clock cycle. Specifically, the mask value generating circuit 31-0 illustrated in FIG. 3 generates a mask value T₀, based on the expression (1). The mask value generating circuits 31-1 to 31-(n−1) generate respective mask values T₁ to Tₙ₋₁, based on the expression (5).

After the mask values T₀ to Tₙ₋₁ are generated, the encryption arithmetic circuits 32-0 to 32-(n−1) generate respective encrypted data C₀ to Cₙ₋₁ in parallel, based on the expressions (2) to (4) (Step S21). In other words, the encryption arithmetic circuits 32-0 to 32-(n−1) simultaneously start processing of generating respective encrypted data C₀ to Cₙ₋₁ (Step S21). The term “parallel processing” used herein means starting generation processing in synchronization with the same clock.

Then, it is determined whether the last block in the sector has been encrypted or not (Step S22). In the case of Yes of Step S22, the encryption processing is ended. In the case of No of Step S22, the mask value generating circuits 31-1 to 31-(n−1) generate the next respective mask values in parallel (Step S23). Thereafter, the encryption arithmetic circuits 32-1 to 32-(n−1) generate a plurality of encrypted data in parallel by using the respective mask values (Step S24). When successive sectors to be encrypted exist, the sector number i is incremented by 1, and the flowchart of FIG. 7 is repeated.

When m is equal to n, all the blocks in a sector are encrypted in parallel by Steps S20 and S21 of FIG. 7.

As described above, by including the same number of mask value generating circuits 31 as encryption arithmetic circuits 32, data to be encrypted in the buffer 24, which temporarily stores a large quantity of data transmitted from the host 10, can be encrypted in parallel.

FIG. 8 is a diagram illustrating a timing for processing a plurality of blocks in a comparative example. FIG. 9 is a diagram illustrating a timing for processing a plurality of blocks according to the present embodiment.

Supposing that the time required for performing encryption processing for a block is V and the time required for performing encryption processing for n blocks is U, U is expressed by the expression “U=V×n” for the comparative example, while U is expressed by the expression “U=V” for the present embodiment. Thereby, the present embodiment enables a significant increase in the speed of encryption processing, in comparison with the comparative example.

Although the encryption operation in the AES-XTS mode is mainly explained in the present embodiment, the similar processing can be performed also for a decryption operation in the AES-XTS mode, except that data flows in the reverse order.

Although the AES-XTS mode is explained as an example in the present embodiment, the present embodiment is also applicable to common key cryptosystems other than the AES-XTS mode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An encryption processing device comprising:
a plurality of generating circuits to generate respective mask values for respective second data units, by using identification information to identify a first data unit and first key data, wherein the first data unit includes the second data units, each of which serves as a unit of an encryption operation; and
a plurality of arithmetic circuits encrypting the respective second data units, by using the respective mask values, the second data units, and second key data,
wherein the generating circuits perform parallel processing.

2. The device of claim 1, wherein the arithmetic circuits simultaneously start an encryption operation.

3. The device of claim 1, wherein the generating circuits include a first generating circuit to generate a first mask value by using the identification information and the first key data, and a plurality of second generating circuits to generate respective second mask values by using the first mask value.

4. The device of claim 1, wherein the generating circuits generate the respective mask values, by multiplying Galois fields.

5. The device of claim 1, wherein each of the arithmetic circuits includes:
a first exclusive OR circuit to calculate an exclusive OR between the mask value and the second data unit, and to output a first calculation result;
an encryption arithmetic unit to perform an operation for a predetermined common key cryptosystem by using the first calculation result and the second key data, and to output a second calculation result; and
a second exclusive OR circuit to calculate an exclusive OR between the second calculation result and the mask value, and to output encrypted data.

6. An encryption processing method comprising:
generating respective mask values for respective second data units, by using identification information to identify a first data unit and first key data, wherein the first data unit includes the second data units, each of which serves as a unit of an encryption operation; and
encrypting the respective second data units, by using the respective mask values, the second data units, and second key data,
wherein the generating respective mask values includes performing parallel processing.

7. The method of claim 6, wherein the encrypting simultaneously starts an encryption operation of the second data units.

8. The method of claim 6, wherein the generating the respective mask values includes generating a first mask value by using the identification information and the first key data, and generating a plurality of mask values by using the first mask value.

9. The method of claim 6, wherein the mask values are generated by multiplying Galois fields.

10. The method of claim 6, wherein the encrypting includes:
calculating an exclusive OR between the mask value and the second data unit, and outputting a first calculation result;
performing an operation for a predetermined common key cryptosystem by using the first calculation result and the second key data, and outputting a second calculation result; and
calculating an exclusive OR between the second calculation result and the mask value, and outputting encrypted data.

11. A storage device comprising:
an encryption processing device to encrypt data transmitted from a host; and
a storage medium to store the encrypted data,
wherein the encryption processing device includes:
a plurality of generating circuits to generate respective mask values for respective second data units, by using identification information to identify a first data unit and first key data, wherein the first data unit includes the second data units, each of which serves as a unit of an encryption operation; and
a plurality of arithmetic circuits to encrypt the second data units, by using the respective mask values, the second data units, and second key data,
wherein the generating circuits perform parallel processing.

12. The device of claim 11, wherein the arithmetic circuits simultaneously start an encryption operation.

13. The device of claim 11, wherein the generating circuits include a first generating circuit to generate a first mask value by using the identification information and the first key data, and a plurality of second generating circuits to generate respective second mask values by using the first mask value.

14. The device of claim 11, wherein the generating circuits generate the respective mask values, by multiplying Galois fields.

15. The device of claim 11, wherein each of the arithmetic circuits includes:
a first exclusive OR circuit to calculate an exclusive OR between the mask value and the second data unit, and to output a first calculation result;
an encryption arithmetic unit to perform an operation for a predetermined common key cryptosystem by using the first calculation result and the second key data, and to output a second calculation result; and
a second exclusive OR circuit to calculate an exclusive OR between the second calculation result and the mask value, and to output encrypted data.

16. The device of claim 11, further comprising:
a first buffer which temporarily stores the first data unit; and
a second buffer which temporarily stores the encrypted data output from the encryption processing device.
